(19) United States
(12) Patent Application Publication
(10) Pub. No.: US 2023/0214695 A1
(43) Pub. Date: Jul. 6, 2023

(54) COUNTERFACTUAL INFERENCE MANAGEMENT DEVICE, COUNTERFACTUAL INFERENCE MANAGEMENT METHOD, AND COUNTERFACTUAL INFERENCE MANAGEMENT COMPUTER PROGRAM PRODUCT

(71) Applicant: HITACHI, LTD., Tokyo (JP)

(72) Inventors: Tong WU, Tokyo (JP); Takuma SHIBAHARA, Tokyo (JP); Yasuho YAMASHITA, Tokyo (JP)

(21) Appl. No.: 18/079,954

(22) Filed: Dec. 13, 2022

(30) Foreign Application Priority Data
Jan. 4, 2022 (JP) 2022-000184

(51) Int. Cl. G06N 5/046; G06V 10/764

(52) U.S. Cl. CPC G06N 5/046; G06V 10/764

(57) ABSTRACT

Aspects relate to providing a counterfactual inference management technique capable of providing increased flexibility to allow users to select an appropriate counterfactual inference and offering scalability for handling tabular data and image data in a single configuration. A counterfactual inference management device comprising a classifier unit trained to determine whether a set of input data that includes a set of data features achieves a predetermined target and a counterfactual inference unit for generating a set of transformed data in which a subset of the set of data features are modified to counterfactual features. The classifier unit processes the set of transformed data to determine whether it achieves the predetermined target and calculates a counterfactual loss. The counterfactual inference unit is trained to reduce the counterfactual loss and generate a set of transformed data including counterfactual features that achieve the predetermined target.

### CROSS-REFERENCE TO RELATED APPLICATIONS

The present application claims priority to Japanese Patent Application No. 2022-000184, filed Jan. 4^{th}, 2022. The contents of this application are incorporated herein by reference in their entirety.

### BACKGROUND OF THE INVENTION

The present disclosure generally relates to a counterfactual inference management device, a counterfactual inference management method, and a counterfactual inference management computer program product.

### SUMMARY OF THE INVENTION

Advances in machine learning models have given rise to an increase in data analysis and predictive capabilities. Counterfactual machine learning models are one tool that can be used to analyze the causal relationships between particular inputs and outputs in a decision-making scenario.

In general, counterfactual machine learning (CFML) refers to the field of machine learning related to using machine learning techniques to identify what could have happened in a particular scenario had an input changed. Counterfactual machine learning can be useful in providing inferences and explanations for why a particular result was returned by a model.

As an example, loan applications are one area in which CFML techniques can be leveraged. For instance, in a loan application for an individual, a machine learning classifier may use information for an applicant (features such as income, educational background, age, marital status) to determine whether to approve or deny a loan. In the case that the applicant is denied a loan, the applicant may wish to know what they could do to increase their likelihood of being approved for a loan in the future. Here, counterfactual machine learning techniques may be used to analyze the relationships between the input features characterizing the applicant and the result, and provide recommendations to the applicant to increase their likelihood of being approved for a future loan application. As an example, a counterfactual machine learning model may provide a recommendation of “Your application is likely to be approved if you increase your income by 10%.” In this way, by using CFML techniques, users can gain valuable insights that assist them in a variety of decision-making scenarios.

Conventionally, a number of CFML techniques have been proposed. For example, Mahajan et. al (Non-Patent Document 1; Mahajan, Divyat, Chenhao Tan, and Amit Sharma. “Preserving causal constraints in counterfactual explanations for machine learning classifiers.” arXiv preprint arXiv:1912.03277 (2019)) discloses “To construct interpretable explanations that are consistent with the original ML model, counterfactual examplesshowing how the model’s output changes with small perturbations to the input---have been proposed. This paper extends the work in counterfactual explanations by addressing the challenge of feasibility of such examples. For explanations of ML models in critical domains such as healthcare and finance, counterfactual examples are useful for an end-user only to the extent that perturbation of feature inputs is feasible in the real world. We formulate the problem of feasibility as preserving causal relationships among input features and present a method that uses (partial) structural causal models to generate actionable counterfactuals. When feasibility constraints cannot be easily expressed, we consider an alternative mechanism where people can label generated CF examples on feasibility: whether it is feasible to intervene and realize the candidate CF example from the original input. To learn from this labelled feasibility data, we propose a modified variational auto encoder loss for generating CF examples that optimizes for feasibility as people interact with its output. Our experiments on Bayesian networks and the widely used “Adult-Income″ dataset show that our proposed methods can generate counterfactual explanations that better satisfy feasibility constraints than existing methods.”

Non-Patent Document 1 discloses a technique for using a modified variational auto encoder loss to generate counterfactual examples with respect to tabular data. More particularly, Non-Patent Document 1 proposes a causal proximity regularizer that can be added to any counterfactual generation method. The proposed proximity loss is based on causal relationships between features, as modeled by a structural causal model (SCM) of input features. This loss can be derived from a partial SCM, or common unary and binary constraints such as monotonic change between features.

In the technique disclosed in Non-Patent Document 1, however, the features input to the model can only be increased or decreased, and only monotonic relationships (e.g., if feature 1 increases feature 2 will increase) are considered, such that the correlation between different features is not taken into account. Additionally, Non-Patent Document 1 does not provide a means for allowing users to make flexible choices between a variety of feasible recommendations. Finally, Non-Patent Document 1 is limited to tabular data, and is not applicable to image data.

Accordingly, it is an object of the present disclosure to provide a counterfactual inference management device, method, and computer program product capable of considering the correlation between features in order to facilitate the elimination of infeasible counterfactual inferences, providing increased flexibility to allow users to select an appropriate counterfactual inference, and offering scalability for handling tabular data and image data in a single configuration.

One representative example of the present disclosure relates to a counterfactual inference management device including a classifier unit trained to determine whether a set of input data that includes a set of data features achieves a predetermined target; and a counterfactual inference unit for generating, by processing the set of input data, a set of transformed data in which a subset of the set of data features are modified to counterfactual features with respect to the set of input data; wherein: the classifier unit processes the set of transformed data generated by the counterfactual inference unit to determine whether the set of transformed data achieves the predetermined target, and calculates a counterfactual loss value associated with a subset of the set of transformed data that does not achieve the predetermined target; and the counterfactual inference unit is trained to reduce the counterfactual loss value and generate a second set of transformed data including counterfactual features that achieve the predetermined target.

According to the present disclosure it is possible to provide a counterfactual inference management device, method, and computer program product capable of considering the correlation between features in order to facilitate the elimination of infeasible counterfactual inferences, providing increased flexibility to allow users to select an appropriate counterfactual inference, and offering scalability for handling tabular data and image data in a single configuration.

Problems, configurations, and effects other than those described above will be made clear by the following description in the embodiments for carrying out the invention.

### BRIEF DESCRIPTION OF THE DRAWINGS

FIG. 1 is a block diagram illustrating an example computing architecture for executing the embodiments of the present disclosure.

FIG. 2 is a diagram illustrating an example logical configuration of a counterfactual inference management device according to the embodiments of the present disclosure.

FIG. 3 is a flowchart illustrating a counterfactual inference management method with respect to tabular data, according to the embodiments of the present disclosure.

FIG. 4 is a flowchart illustrating an overall flow of a counterfactual inference management method with respect to image data, according to the embodiments of the present disclosure.

FIG. 5 is a flowchart illustrating a detailed flow of a counterfactual inference generation method with respect to tabular data, according to the embodiments of the present disclosure.

FIG. 6 is a flowchart illustrating a detailed flow of a counterfactual inference generation method with respect to image data, according to the embodiments of the present disclosure.

FIG. 7 is a diagram illustrating an example of a training process for the classifier unit and the counterfactual inference unit, according to the embodiments of the present disclosure.

FIG. 8 is a diagram illustrating an example of a feedback process of the counterfactual inference management device, according to the embodiments of the present disclosure.

FIG. 9 is a diagram illustrating an example of a mask selection window, according to the embodiments of the present disclosure.

FIG. 10 is a diagram illustrating an example of an image import window according to the embodiments of the present disclosure.

FIG. 11 is a diagram illustrating an example of a counterfactual inference result display for tabular data, according to the embodiments of the present disclosure.

FIG. 12 is a diagram illustrating an example of a counterfactual inference result display for image data, according to the embodiments of the present disclosure.

### DETAILED DESCRIPTION

Hereinafter, embodiments of the present invention will be described with reference to the Figures. It should be noted that the embodiments described herein are not intended to limit the invention according to the claims, and it is to be understood that each of the elements and combinations thereof described with respect to the embodiments are not strictly necessary to implement the aspects of the present invention.

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter.

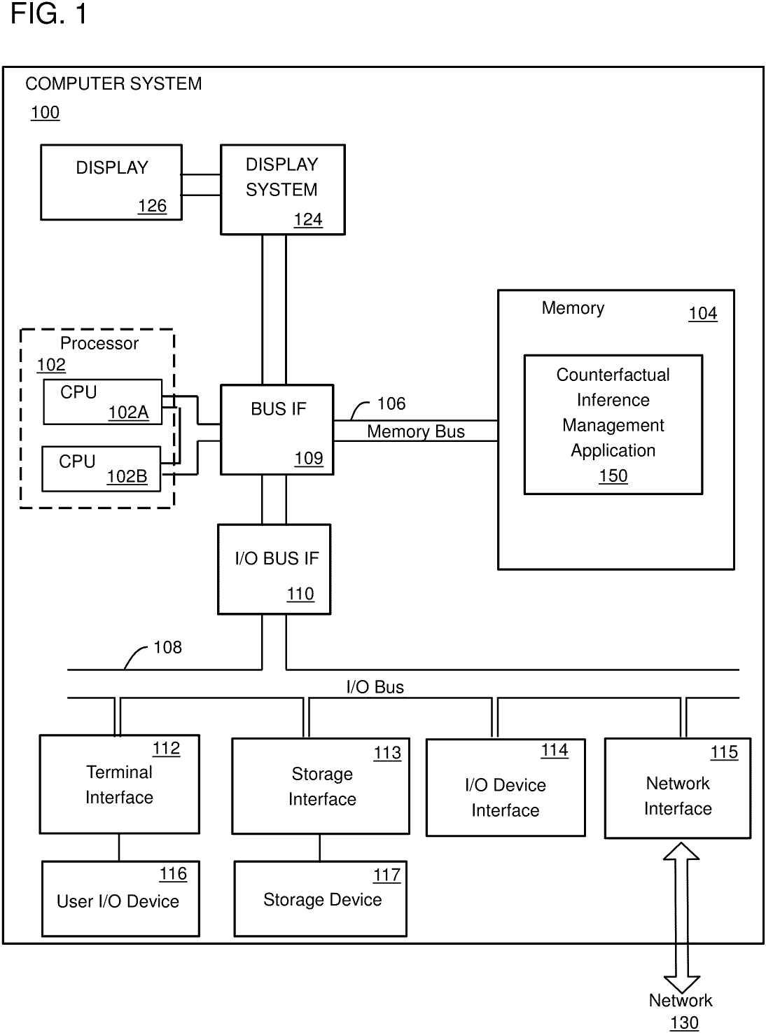

Turning now to the Figures, FIG. 1 depicts a high-level block diagram of a computer system 100 for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal intrface 112, a storage intrface 113, an I/O (Input/Output) device interface 114, and a network interface 115, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called nonuniform memory access (NUMA) computer architectures.

The memory 104 may store all or a portion of the various programs, modules and data structures for processing data transfers as discussed herein. For instance, the memory 104 can store a counterfactual inference management application 130. In embodiments, the counterfactual inference management application 130 may include instructions or statements that execute on the processor 102 or instructions or statements that are interpreted by instructions or statements that execute on the processor 102 to carry out the functions as further described below.

In certain embodiments, the counterfactual inference management application 130 is implemented in hardware via semiconductor devices, chips, logical gates, circuits, circuit cards, and/or other physical hardware devices in lieu of, or in addition to, a processor-based system. In embodiments, the counterfactual inference management application 130 may include data in addition to instructions or statements. In certain embodiments, a camera, sensor, or other data input device (not shown) may be provided in direct communication with the bus interface unit 109, the processor 102, or other hardware of the computer system 100. In such a configuration, the need for the processor 102 to access the memory 104 and the counterfactual inference management application 130 may be reduced.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 113, 114, and 115, which are also known as I/O processors (IOPs) or I/O adapters (IOAs), through the I/O bus 108. The display system 124 may include a display controller, a display memory, or both. The display controller may provide video, audio, or both types of data to a display device 126. Further, the computer system 100 may include one or more sensors or other devices configured to collect and provide data to the processor 102.

As examples, the computer system 100 may include biometric sensors (e.g., to collect heart rate data, stress level data), environmental sensors (e.g., to collect humidity data, temperature data, pressure data), motion sensors (e.g., to collect acceleration data, movement data), or the like. Other types of sensors are also possible. The display memory may be a dedicated memory for buffering video data. The display system 124 may be coupled with a display device 126, such as a standalone display screen, computer monitor, television, or a tablet or handheld device display.

In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 116, which may include user output devices (such as a video display device, speaker, and/or television set) and user input devices (such as a keyboard, mouse, keypad, touchpad, trackball, buttons, light pen, or other pointing device). A user may manipulate the user input devices using a user interface in order to provide input data and commands to the user I/O device 116 and the computer system 100, and may receive output data via the user output devices. For example, a user interface may be presented via the user I/O device 116, such as displayed on a display device, played via a speaker, or printed via a printer.

The storage intrface 113 supports the attachment of one or more disk drives or direct access storage devices 117 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 117 may be implemented via any type of secondary storage device. The contents of the memory 104, or any portion thereof, may be stored to and retrieved from the storage device 117 as needed. The I/O device interface 114 provides an interface to any of various other I/O devices or devices of other types, such as printers or fax machines. The network interface 115 provides one or more communication paths from the computer system 100 to other digital devices and computer systems; these communication paths may include, for example, one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

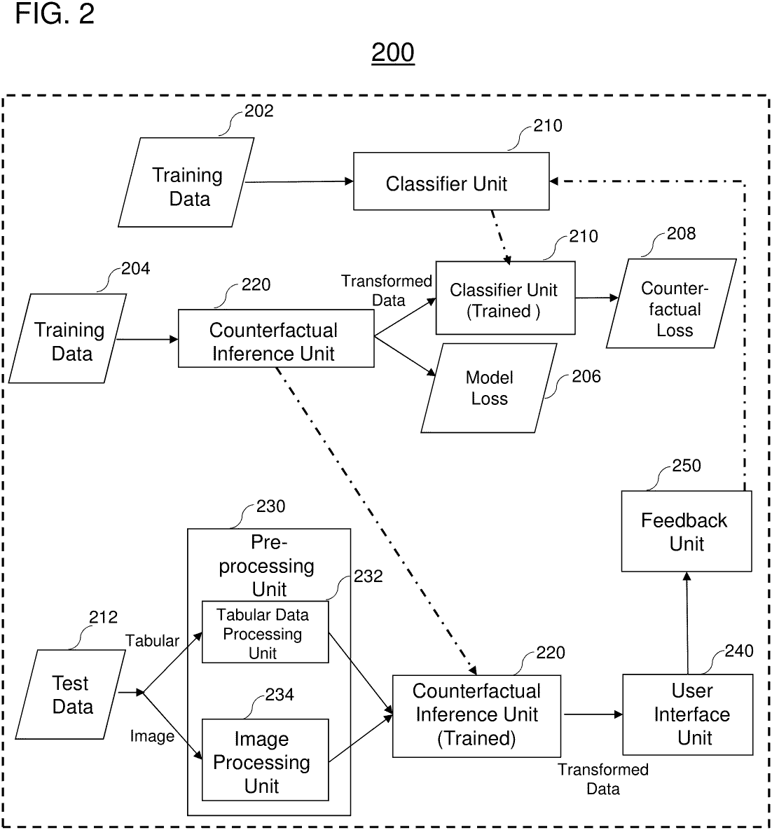

Next, an example logical configuration of a counterfactual inference management device according to the embodiments of the present disclosure will be described with reference to FIG. 2.

FIG. 2 is a diagram illustrating the logical configuration of a counterfactual inference management device 200 according to the embodiments of the present disclosure. As illustrated in FIG. 2, the counterfactual inference management device 200 primarily includes a classifier unit 210, a counterfactual inference unit 220, a pre-processing unit 230, a user interface unit 240, and a feedback unit 250 (hereinafter collectively referred to as “functional units”). Each of the functional units herein may be implemented, for instance, as a software module within the counterfactual inference management application 130 executed by the computer system 100 illustrated in FIG. 1, or as a dedicated hardware unit.

In embodiments, the counterfactual inference management device 200 may be configured in three phases including a classifier training phase for training the classifier unit 210, a counterfactual inference unit training phase for training the counterfactual inference unit 220, and an inference phase in which the trained counterfactual inference unit 220 is used to generate a counterfactual inference result.

First, in the classifier training phase, the classifier unit 210 is trained using a set of training data 202. The classifier unit 210 is a functional unit configured to determine whether an input data set that includes a set of data features achieves a predetermined target (e.g., loan approval). More particularly, the classifier unit 210 may order or categorize data into one or more of a set of classes.

As an example, the classifier unit 21 may include an algorithm configured to classify loan applicants into classes of “approved” or “denied” based upon features that define the characteristics (income, educational background, age, marital status) of the applicant. In this example, applicants that are “approved” are considered to achieve the predetermined target, and applicants that are “denied” are considered to fail to achieve the predetermined target. The set of training data 202 may include a set of data (image data or tabular data) used for training the classifier unit 210 to perform a given classification task. For instance, with reference to the loan application example, the set of training data 202 may include data including features that define the characteristics of a number of applicants that can be used to train the classifier unit 210 to accurately classify applicants into categories of “approved” or “denied.” In general, “training” refers to adjusting the parameters (e.g., hyper parameters, weights, and neural connections) of a machine learning unit until a particular task can be performed with a predetermined accuracy. This training can be performed over a plurality of iterations until the desired accuracy is achieved.

As the flow of the training process of the classifier unit 210 will be described later, the details thereof will be omitted here.

In the counterfactual inference unit training phase, the counterfactual inference unit 220 is trained using a set of training data 204. The counterfactual inference unit 220 is a functional unit configured to perform encoding and decoding operations on an input data set to generate a set of transformed data that achieves the predetermined target. The counterfactual inference unit 220 may be implemented as a variational autoencoder, for instance. The set of training data 204 may include a set of data (image data or tabular data) used for training the counterfactual inference unit 220. In embodiments, the set of training data 204 may substantially correspond to the set of training data 202 used to train the classifier unit 210.

In embodiments, the counterfactual inference unit 220 may be configured to switch between separate operating modes based on the type of input data. For instance, an operating configuration trained to handle image data and an operating configuration trained to handle tabular data may be prepared in advance, and the counterfactual inference unit 220 may be configured to load the operating configuration for processing tabular data in the case that the set of input data is tabular data and load the operating configuration for processing image data in the case that the set of input data is image data. In this way, the counterfactual inference management device 200 is capable of generating counterfactual inference results with respect to both tabular data and image data.

Here, the set of transformed data (not illustrated in FIG. 2) is a set of data in which a subset of the set of data features of the input data set are modified to counterfactual features. A “counterfactual feature” refers to a data feature having a value or characteristic that differs from the actual value or characteristic. These counterfactual features may be used to represent counterfactual inferences. Here, a “counterfactual inference” refers to a hypothetical state defined using one or more counterfactual features. These counterfactual inferences may be used to help users understand how a given output would change based on hypothetical changes to the input.

As an example, a user associated with a data feature of “Educational Background- High school graduate” may modify this data feature to a counterfactual feature of “Educational Background: Bachelor’s Degree in Business Management” to explore how this affects their career option. In addition, the set of transformed data may indicate the correlation between different clusters of data features (e.g., education level and income).

The encoding and decoding operations performed on the set of input data result in a model loss 206 associated with the difference between the set of transformed data and the set of training data 204. The set of transformed data is input to the classifier unit 210 trained in the classifier training phase. The trained classifier unit 210 processes the set of transformed data generated by the counterfactual inference unit 220 to determine whether the set of transformed data achieves a predetermined target (e.g., loan approval), and calculates a counterfactual loss 208 associated with a portion of the set of transformed data that does not achieve the predetermined target. Subsequently, the counterfactual inference unit 220 is trained to reduce the model loss 206 (including the reconstruction loss 206). In this way, the counterfactual inference unit 220 is trained to generate sets of transformed data that include counterfactual features that achieve the predetermined target.

As the flow of the training process of the counterfactual inference unit 220 will be described later, the details thereof will be omitted here.

In the inference phase, the trained counterfactual inference unit 220 is used to generate a counterfactual inference result with respect to a set of test data 212. The set of test data 212 may include a set of data (image data or tabular data) about which a set of counterfactual inferences are to be generated.

First, the set of test data 212 may be input to the pre-processing unit 230. The pre-processing unit 230 is a functional unit configured to perform one or more pre-processing operations on the set of test data 212 to facilitate the generation of counterfactual inferences. More particularly, in embodiments, the pre-processing unit 230 may analyze the set of test data 212 to determine whether the set of test data 212 includes a set of tabular data or a set of image data. In the case that the set of test data 212 is determined to include a set of tabular data, the pre-processing unit 230 may use a tabular data processing unit 232 to perform a tabular data processing operation (e.g., normalize a set of data features, mask a subset of data features to prevent modification by the counterfactual inference unit 220, or the like) on the set of test data 212. In the case that the set of test data 212 is determined to include a set of image data, the pre-processing unit 230 may use an image processing unit 234 to perform an image processing operation (e.g., a pixel brightness operation, a geometric transformation) on the set of test data 212.

After the set of test data 212 has been processed by the pre-processing unit 230, it is input to the counterfactual inference unit 220 trained in the counterfactual inference unit training phase described above. The counterfactual inference unit 220 processes the pre-processed set of test data 212 to generate a set of transformed data in which a subset of the set of data features of the set of test data 212 have been modified to counterfactual features such that the set of transformed data achieves the predetermined target (e.g., loan approval). The set of transformed data is then input to the user interface unit 240.

The user interface unit 240 is a functional unit configured to display information and receive inputs from users via a graphical user interface. In embodiments, the user interface unit 240 may be configured to present a counterfactual inference result that includes the set of transformed data generated by the counterfactual inference unit 220 as well as the set of data features associated with the set of transformed data and a target achievement indicator that indicates whether the set of transformed data achieves the predetermined target. The user interface unit 240 may also indicate the correlation between different clusters of data features. The user interface unit 240 may receive a user input to further modify one or more of the data features of the set of transformed data to a user-selected counterfactual feature (e.g., a user may modify a data feature corresponding to their income or education level to observe how this affects their loan approval result).

The feedback unit 250 may collect the user input including the set of user-selected counterfactual features, and use this set of user-selected counterfactual features to generate training data to further train the classifier unit 210.

As the flow of the inference phase will be described later, the details thereof will be omitted here.

According to the counterfactual inference management device 200 described above, it is possible to consider the correlation between features in order to facilitate the elimination of infeasible counterfactual inferences, provide increased flexibility to allow users to select an appropriate counterfactual inference, and offer scalability for handling tabular data and image data in a single configuration.

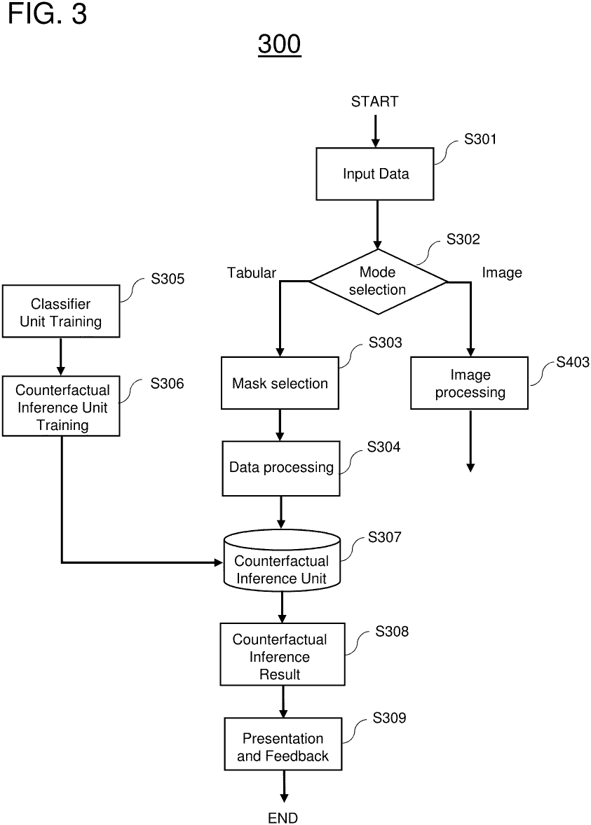

Next, a counterfactual inference management method with respect to tabular data according to the embodiments of the present disclosure will be described with reference to FIG. 3.

FIG. 3 is a flowchart illustrating an overall flow of a counterfactual inference management method 300 with respect to tabular data, according to embodiments of the present disclosure. As described herein, aspects of the disclosure relate to an inference management method capable of generating counterfactual inference results with respect to both tabular data and image data in a single configuration. Accordingly, the counterfactual inference management method 300 depicted in FIG. 3 illustrates a method for generating counterfactual inferences with respect to a set of tabular data. The counterfactual inference management method 300 may be performed by the various functional units of the counterfactual inference management device 200 illustrated in FIG. 2.

It should be noted that the counterfactual inference management method 300 corresponds to the inference phase of the counterfactual inference management device 200; that is, the classifier unit and the counterfactual inference unit are assumed to already have been trained. As the training processes of the classifier unit and the counterfactual inference unit will be described later, the details thereof will be omitted here.

First, at Step S301, the pre-processing unit (for example, the pre-processing unit 230 illustrated in FIG. 2) receives a set of input data. As described herein, the set of input data may be a set of test data for which a counterfactual inference result is to be generated. Further, the set of input data may include either a set of tabular data or a set of image data. Here, tabular data refers to information that is structured in the form of a table (e.g., organized in columns and rows).

The set of input data may include a set of data features. Here, the set of data features refer to a collection of properties or attributes that characterize the set of input data. In the case of tabular data, the set of data features may include a set of numerical features or a set of categorical features. As an example, in the case that the set of input data includes personal information provided by a loan applicant for use in determining their eligibility to qualify for a loan, the set of data features may include numerical features such as the age of the applicant, the income of the applicant, or the like, as well as categorical features such as the gender of the applicant, the educational level of the applicant, the occupation of the applicant, or the like.

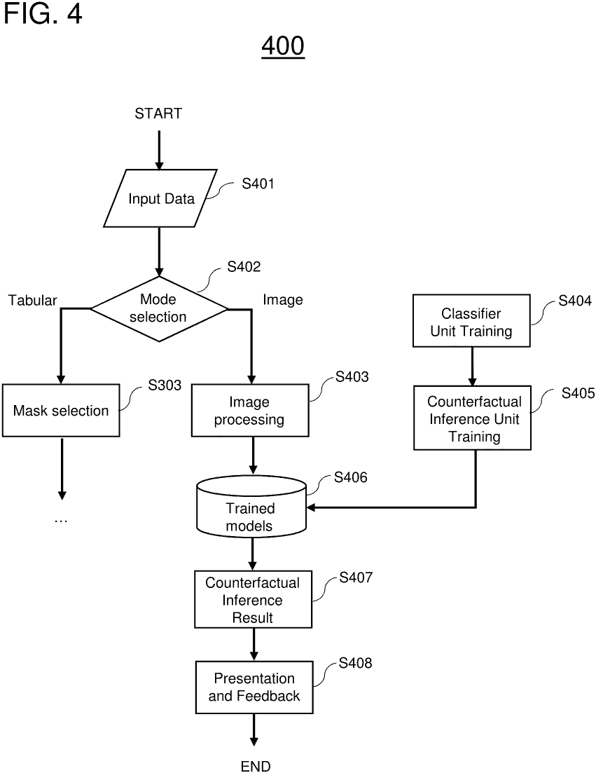

Next, at Step S302, the pre-processing unit performs a mode selection operation to determine whether the set of input data is a set of tabular data or a set of image data. In the case that the set of input data includes a set of tabular data, the processing proceeds to Step S303. In the case that the set of input data includes a set of image data, the processing proceeds to Step S403. Note that, as the overall flow of a counterfactual inference management method 400 with respect to image data will be described with reference to FIG. 4, here it is assumed that the set of input data includes a set of tabular data.

Next, at Step S303, the tabular data processing unit (that is, the tabular data processing unit 232 of the pre-processing unit 230) performs a masking operation with respect to the set of input data. Here, the masking operation refers to an operation to mask (e.g., freeze, lock, hold, maintain) one or more of the data features of the set of input data. Features that are masked are prevented from being modified by the processing of the counterfactual inference unit, as will be described later.

Next, at Step S304, the tabular data processing unit performs a tabular data processing operation with respect to the set of data features of the set of input data that were not masked in Step S303. Here, the tabular data processing operation may include an operation to facilitate processing by the counterfactual inference unit. As examples, the tabular data processing unit may utilize a normalization technique to normalize numerical features (e.g., age, income, hours worked per week) of the set of input data, or a one-hot encoding feature to represent the categorical features (e.g., occupation, educational level, marital status) of the input data in a vector format. Performing the tabular data processing operation with respect to the set of input data may increase the accuracy of the counterfactual inference unit.

At Step S305, the classifier unit is trained to determine whether an input data set that includes a set of data features achieves a predetermined target. More particularly, the classifier unit may be trained to order or categorize data into one or more of a set of classes. Here, the predetermined target refers to a particular goal or classification defined in advance. As an example, in the case of a loan application scenario, the predetermined target may be “loan approval.” As the training process of the classifier unit will be described later, the details thereof will be omitted here.

At Step S306, the counterfactual inference unit is trained to perform encoding and decoding operations on the set of input data set to generate a set of transformed data that achieves the predetermined target. As the training process of the counterfactual inference unit will be described later, the details thereof will be omitted here.

As described herein, the training process of the classifier unit in Step S305 and the training process of the counterfactual inference unit in Step S306 are independent steps that can be performed in advance, and are assumed to be completed prior to the pre-processed data being input to the counterfactual inference unit (that is, the counterfactual inference unit is trained prior to receiving the pre-processed set of input data).

Next, at Step S307, the set of input data pre-processed at Step S304 is input to the counterfactual inference unit trained at Step S306, and at Step S308, the counterfactual inference unit generates a counterfactual inference result at least including a set of transformed data in which a subset of the set of data features of the set of input data have been modified to counterfactual features such that the set of transformed data achieves the predetermined target (e.g., loan approval).

As the processing performed by the counterfactual inference unit to generate the set of transformed data will be described later, the details thereof will be omitted here.

Next, at Step S309, the user interface unit (e.g., the user interface unit 240 illustrated in FIG. 2) presents, to a user via a user interface unit, a counterfactual inference result that includes the set of transformed data generated by the counterfactual inference unit in Step S308 as well as the set of data features associated with the set of transformed data and a target achievement indicator that indicates whether the set of transformed data achieves the predetermined target. The user interface unit may also indicate the correlation between different clusters of data features. The user interface unit may receive a user input to further modify one or more of the data features of the set of transformed data to a user-selected counterfactual feature (e.g., a user may modify a data feature corresponding to their income or education level to observe how this affects their loan approval result). Further, the feedback unit 250 may collect the user input including the set of user-selected counterfactual features, and use this set of user-selected counterfactual features to generate training data to further train the classifier unit.

According to the counterfactual inference management method 300 with respect to tabular data described above, it is possible to generate a counterfactual inference result for tabular data that provides users with increased flexibility to select an appropriate counterfactual inference, and utilize the user input to further increase the accuracy of the counterfactual inference management device.

Next, a counterfactual inference management method with respect to image data according to the embodiments of the present disclosure will be described with reference to FIG. 4.

FIG. 4 is a flowchart illustrating an overall flow of a counterfactual inference management method 400 with respect to image data, according to the embodiments of the present disclosure. As described herein, aspects of the disclosure relate to an inference management method capable of generating counterfactual inferences with respect to both tabular data and image data in a single configuration. Accordingly, the counterfactual inference management method 400 depicted in FIG. 4 illustrates a method for generating counterfactual inferences with respect to a set of image data. The counterfactual inference management method 400 may be performed by the various functional units of the counterfactual inference management device 200 illustrated in FIG. 2.

It should be noted that the counterfactual inference management method 400 corresponds to the inference phase of the counterfactual inference management device 200; that is, the classifier unit and the counterfactual inference unit are assumed to already have been trained. As the training processes of the classifier unit and the counterfactual inference unit will be described later, the details thereof will be omitted here.

First, at Step S401, the pre-processing unit (for example, the pre-processing unit 230 illustrated in FIG. 2) receives a set of input data. As described herein, the set of input data may be a set of test data for which a counterfactual inference result is to be generated. Further, the set of input data may include either a set of tabular data or a set of image data. Here, image data refers to information that is represented in a graphical or pictorial form.

The set of input data may include a set of data features. Here, the set of data features refer to a collection of properties or attributes that characterize the set of input data. In the case of image data, the set of data features may include a set of image features. As an example, in the case that the set of input data includes an image of a bedroom, the set of data features may include image features such as the lighting of the room, the angle of the image, spatial composition of the image, classes of objects present in the image, colors of the objects, or the like. However, the set of image features are not limited herein, and other image features, such as weather or the like, may also be utilized.

Next, at Step S402, the pre-processing unit performs a mode selection operation to determine whether the set of input data is a set of tabular data or a set of image data. In the case that the set of input data includes a set of tabular data, the processing proceeds to Step S303. In the case that the set of input data includes a set of image data, the processing proceeds to Step S403. Note that, as the overall flow of a counterfactual inference management method 300 with respect to tabular data was previously described with reference to FIG. 3, here it is assumed that the set of input data includes a set of image data.

Next, at Step S403, the image processing unit (that is, the image processing unit 234 of the pre-processing unit 230) performs an image processing operation with respect to the set of input data. Here, the image processing operation refers to an operation to facilitate processing by the counterfactual inference unit. As examples, the image processing unit may utilize a pixel brightness transformation or a geometric transformation to modify the set of image data. Performing the image processing operation with respect to the set of input data may increase the accuracy of the counterfactual inference unit.

At Step S404, the classifier unit is trained to determine whether an input data set that includes a set of data features achieves a predetermined target (e.g., whether there is indoor lighting in an image of a bedroom, whether an image shows a cat). More particularly, the classifier unit may be trained to order or categorize data into one or more of a set of classes. As the training process of the classifier unit will be described later, the details thereof will be omitted here.

At Step S405, the counterfactual inference unit is trained to perform encoding and decoding operations on the set of input data set to generate a set of transformed data that achieves the predetermined target. As the training process of the counterfactual inference unit will be described later, the details thereof will be omitted here.

As described herein, the training process of the classifier unit in Step S404 and the training process of the counterfactual inference unit in Step S405 are independent steps that can be performed in advance, and are assumed to be completed prior to the pre-processed data being input to the counterfactual inference unit (that is, the counterfactual inference unit is trained prior to receiving the pre-processed set of input data).

Next, at Step S406, the set of input data pre-processed at Step S403 is input to the counterfactual inference unit trained at Step S405, and at Step S407, the counterfactual inference unit generates a counterfactual inference result that at least includes a set of transformed data in which a subset of the set of data features of the set of input data have been modified to counterfactual features such that the set of transformed data achieves the predetermined target (e.g., an image of a bedroom with no indoor lighting is transformed to an image with indoor lighting).

As the processing performed by the counterfactual inference unit to generate the set of transformed data will be described later, the details thereof will be omitted here.

Next, at Step S408, the user interface unit (e.g., the user interface unit 240 illustrated in FIG. 2) presents, to a user via a user interface unit, a counterfactual inference result that includes the set of transformed data generated by the counterfactual inference unit in Step S406 as well as the set of data features associated with the set of transformed data. The user interface unit may receive a user input to further modify one or more of the data features of the set of transformed data to a user-selected counterfactual feature (e.g., a user may modify a data feature corresponding to the brightness of the image to observe how this affects the visibility). Further, the feedback unit 250 may collect the user input including the set of user-selected counterfactual features, and use this set of user-selected counterfactual features to generate training data to further train the classifier unit.

According to the counterfactual inference management method 400 with respect to image data described above, it is possible to generate a counterfactual inference result for image data that provides users with increased flexibility to select an appropriate counterfactual inference, and utilize the user input to further increase the accuracy of the counterfactual inference management device.

In this way, by means of the pre-processing performing a mode selection operation to determine whether a set of input data is tabular data or image data, and subsequently using a tabular data processing unit to process tabular data features such as numerical features or categorical features, or alternatively using an image data processing unit to process image data features, it is possible to generate counterfactual inferences for both tabular data and image data with a single configuration.

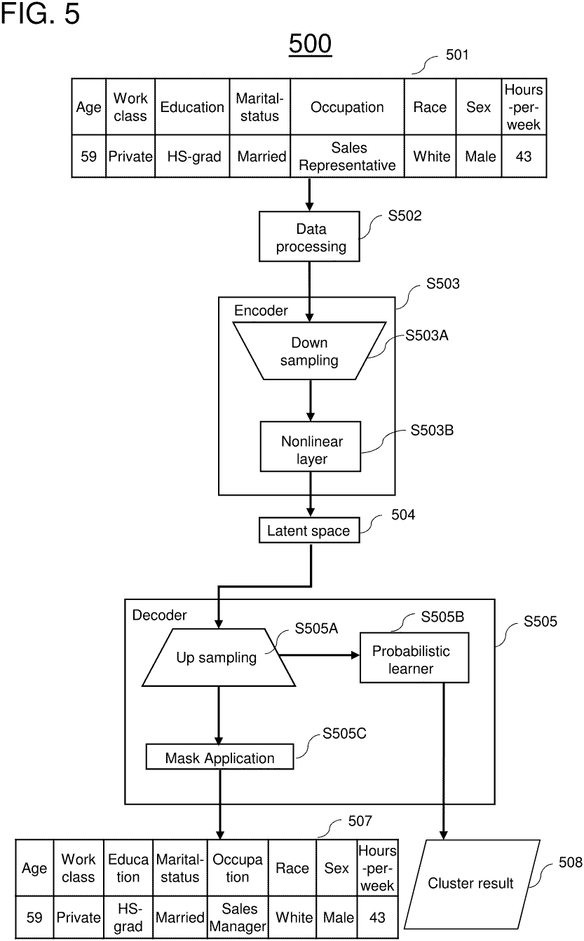

Next, a counterfactual inference generation method with respect to tabular data according to the embodiments of the present disclosure will be described with reference to FIG. 5.

FIG. 5 is a flowchart illustrating a detailed flow of a counterfactual inference generation method 500 with respect to tabular data, according to embodiments of the present disclosure. The counterfactual inference generation method 500 with respect to tabular data illustrates the detailed steps of generating a counterfactual inference result with respect to tabular data, and substantially corresponds to Steps S304-S309 as illustrated in FIG. 3.

Here, for convenience of explanation, an example of a counterfactual inference generation method 500 with respect to tabular data related to a loan application scenario will be described, but the present disclosure is not limited hereto, and counterfactual inference generation may be applied to a variety of use cases.

First, at Step S502, the pre-processing unit (for example, the pre-processing unit 230 illustrated in FIG. 2) receives a set of tabular data 501 as a set of input data. As described herein, the set of tabular data 501 refers to information that is structured in the form of a table (e.g., organized in columns and rows). The set of tabular data 501 may include, as a set of data features, a set of numerical features and/or a set of categorical features. For example, as illustrated in FIG. 5, in the case that the set of tabular data 501 includes personal information provided by a loan applicant for use in determining their eligibility to qualify for a loan, the set of data features may include numerical features such as the age of the applicant or the hours worked per week of the applicant, as well as categorical features such as the work class of the applicant, the education level of the applicant, the marital status of the applicant, the occupation of the applicant, and the gender of the applicant.

Upon receiving the set of tabular data 501, the tabular data processing unit performs a tabular data processing operation with respect to the set of data features of the set of tabular data 501 (e.g., the set of data features for which a mask was not designated in Step S303 illustrated in FIG. 3). Here, the tabular data processing operation may include an operation to facilitate processing by the counterfactual inference unit. As examples, the tabular data processing unit may utilize a normalization technique to normalize the numerical features (e.g., age, income, hours worked per week) of the set of tabular data 501, or a one-hot encoding feature to represent the categorical features (e.g., occupation, educational level, marital status) of the set of tabular data 501 in a vector format.

Next, at Step S503, the set of tabular data 501 pre-processed at Step S502 is input to the encoder of the counterfactual inference unit. Here, the encoder is a neural network configured to compress and dimensionally reduce the set of tabular data 501 to generate a latent space representation 504 of the set of tabular data 501.

More particularly, at Step S503A, the encoder performs down sampling on the set of tabular data 501. This down sampling may be performed in a down sampling layer of the neural network used as the encoder. Performing down sampling on the set of tabular data 501 allows for the essential data features of the set of tabular data 501 to be maintained while reducing the overall dimensionality of the set of tabular data 501 and suppress noise.

Next, at Step S503B, the encoder processes the set of tabular data with a non-linear layer. The non-linear layer may utilize a non-linear activation function, such as a rectified linear unit (ReLU) activation function to introduce non-linearities to the set of tabular data 501.

By processing the set of tabular data 501, the encoder generates a latent space representation 504 of the set of tabular data 501. Here, the latent space representation 504 is a dimensionally reduced representation of the set of tabular data 501. In embodiments, the latent space representation 504 may include a multi-dimensional vector that characterizes the primary data features of the set of tabular data 501.

Next, at Step S505, the latent space representation 504 is input to the decoder of the counterfactual inference unit. Here, the decoder is a neural network configured to decode the latent space representation 504 in order to generate a reconstructed version of the set of tabular data 501.

More particularly, at Step S505A, the decoder performs up sampling on the latent space representation 504. This up sampling may be performed in an up-sampling layer of the neural network used as the decoder. Performing up-sampling on the latent space representation 504 decodes the latent space representation 504 to generate a set of transformed data 507 in which a subset of the set of data features are modified to counterfactual features with respect to the set of tabular data 501.

In addition, at Step S505B, the decoder uses a probabilistic learner layer to determine the correlation between the data features of the set of transformed data 507. The probabilistic learner layer may utilize a statistical analysis technique to predict data features that have a high probability of exhibiting correlation with one or other data features of the set of transformed data 507. Here, “correlation” refers to a co-dependent relationship between two or more data features, such that a change in one data feature leads to a change in another data feature. As an example, the probabilistic learner layer may identify correlation between data features of “age” and “education level,” as changes to an individuals’ education level often take time, which would result in corresponding changes to the age of the individual.

Further, at Step S505C, the decoder applies masks to the subset of data features selected for mask application in Step S303, as described above. Here, applying masks to the subset of data features may include modifying the values of the subset of data features selected for mask application to the same value as the set of tabular data 501, thereby maintaining them at the original value. As an example, the decoder may apply masks to data features that cannot be changed by the user (e.g., race, gender) or the like.

The decoder outputs a counterfactual inference result at least including the set of transformed data 507 together with the cluster results 508 generated by the probabilistic learner in Step S505B.

As described herein, as the counterfactual inference unit used here has been trained to perform encoding and decoding operations on the set of tabular data 501 to generate a set of transformed data that achieves the predetermined target, the set of transformed data 507 is a set of data in which a subset of the set of data features of the set of tabular data are modified to counterfactual features to increase the likelihood of the set of transformed data achieving the predetermined target (e.g., loan approval). For instance, as illustrated in FIG. 5, in the set of transformed data 507, the data feature of “Occupation-Sales Representative” has been changed to a counterfactual feature of “Occupation- Sales Manager.” That is, by changing their occupation from “Sales Representative” to “Sales Manager,” an applicant may have a higher likelihood of being approved for a loan. Accordingly, the applicant may use this counterfactual inference as a recommendation for increasing their likelihood of being approved for a loan.

Further, the cluster result 508 indicates those data features that are determined to have correlation to each other. As will be described later, the user may use this correlation to eliminate non-feasible counterfactual inferences, and select more feasible counterfactual inferences.

According to the counterfactual inference generation method 500 with respect to tabular data described above, it is possible to generate a counterfactual inference result for tabular data that provides users with recommendations of what attributes (e.g., data features) to change to increase their likelihood of achieving a predetermined target.

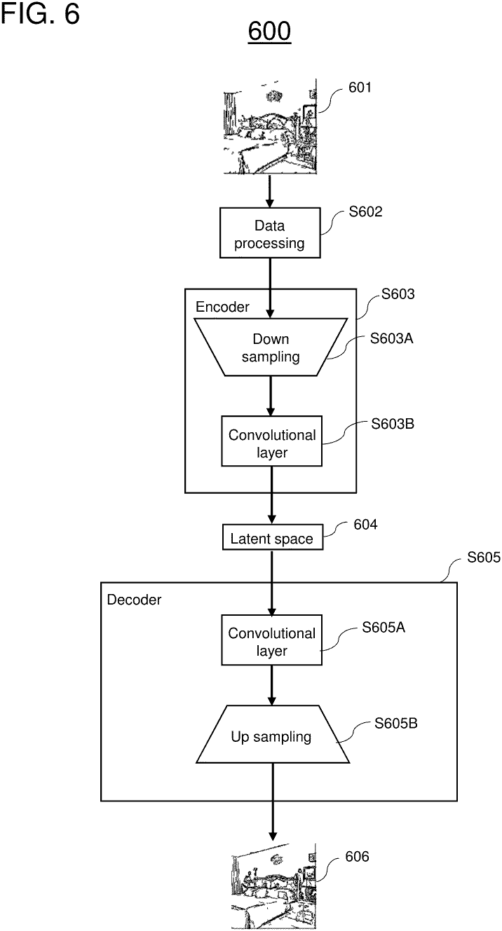

Next, a counterfactual inference generation method with respect to image data according to the embodiments of the present disclosure will be described with reference to FIG. 6.

FIG. 6 is a flowchart illustrating a detailed flow of a counterfactual inference generation method 600 with respect to image data, according to embodiments of the present disclosure. The counterfactual inference generation method 600 with respect to image data illustrates the detailed steps of generating a counterfactual inference result with respect to image data, and substantially corresponds to Steps S403-S408 as illustrated in FIG. 4.

Here, for convenience of explanation, an example of a counterfactual inference generation method 600 with respect to image data illustrating a bedroom will be described, but the present disclosure is not limited hereto, and counterfactual inference generation may be applied to a variety of use cases.

First, at Step S602, the pre-processing unit (for example, the pre-processing unit 230 illustrated in FIG. 2) receives a set of image data 601 as a set of input data. As described herein, the set of image data 601 refers to information that is represented in a graphical or pictorial form. The set of image data 601 may include, as a set of data features, a set of image features. For example, as illustrated in FIG. 6, in the case that the set of image data 601 is an image of a bedroom, the set of data features may include image features such as the lighting of the room, the angle of the image, spatial composition of the image, classes of objects present in the image, colors of the objects, or the like.

Upon receiving the set of image data 601, the image processing unit (that is, the image processing unit 234 of the pre-processing unit 230) performs an image processing operation with respect to the set of image data 601. Here, the image processing operation refers to an operation to facilitate processing by the counterfactual inference unit. As examples, the image processing unit may utilize a pixel brightness transformation or a geometric transformation to modify the set of image data. Performing the image processing operation with respect to the set of input data may increase the accuracy of the counterfactual inference unit.

Next, at Step S603, the set of image data 601 pre-processed at Step S602 is input to the encoder of the counterfactual inference unit. Here, the encoder is a neural network configured to compress and dimensionally reduce the set of image data 601 to generate a latent space representation 604 of the set of image data 601.

More particularly, at Step S603A, the encoder performs down sampling on the set of image data 601. This down sampling may be performed in a down sampling layer of the neural network used as the encoder. Performing down sampling on the set of image data 601 allows for the essential data features of the set of image data 601 to be maintained while reducing the overall dimensionality of the set of image data 601 and suppress noise.

Next, at Step S603B, the encoder processes the set of image data 601 with a convolutional layer. Here, the convolutional layer is a neural network layer configured to process the set of image data to extract a feature map. The feature map is a vectorial representation of the set of image data 601. As examples, the convolutional network may include LeNet, AlexNet, VGG-16 Net, Resnet, Inception Net, or the like.

By processing the set of image data 601, the encoder generates a latent space representation 604 of the set of image data 601. Here, the latent space representation 604 is a dimensionally reduced representation of the set of image data 601. In embodiments, the latent space representation 604 may include a multi-dimensional vector that characterizes the primary data features of the set of image data 601.

Next, at Step S605, the latent space representation 604 is input to the decoder of the counterfactual inference unit. Here, the decoder is a neural network configured to decode the latent space representation 604 in order to generate a reconstructed version of the set of image data 601.

More particularly, at Step S6505A, a convolutional layer is used to reconstruct an image from the latent space representation 604.

Subsequently, at Step S605B, the decoder performs up sampling on the image generated by the convolutional network from the latent space representation 604. This up sampling may be performed in an up-sampling layer of the neural network used as the decoder.

In this way, the decoder is able to generate a counterfactual inference result at least including a set of transformed data 606 in which a subset of the set of image features have been modified to counterfactual features. As described herein, as the counterfactual inference unit used here has been trained to perform encoding and decoding operations on the set of image data 601 to generate a set of transformed data that achieves a predetermined target, the set of transformed data 606 is a set of data in which a subset of the set of data features of the set of image data 601 are modified to counterfactual features to increase the likelihood of the set of transformed data achieving the predetermined target (e.g., modifying an image in which no indoor lighting is present to an image of a room in which indoor lighting is present). For instance, as illustrated in FIG. 6, in the set of transformed data 606, a data feature of “Indoor Lighting-Off” has been changed to a counterfactual feature of “Indoor Lighting-On.” In this way, it is possible to generate sets of transformed data 606 having images that illustrate scenarios different from those illustrated in the original set of image data 601.

According to the counterfactual inference generation method 600 with respect to image data described above, it is possible to generate a counterfactual inference result for image data that provides users with transformed images that achieve a predetermined target. In embodiments, these transformed images may be used as training data for other machine language models. For instance, transformed images that illustrate rare scenarios (e.g., a bear crossing a road) may be generated from input images illustrating more common scenarios (e.g., a dog crossing a road). These transformed images may then be used to supplement machine learning in situations where data availability is an issue.

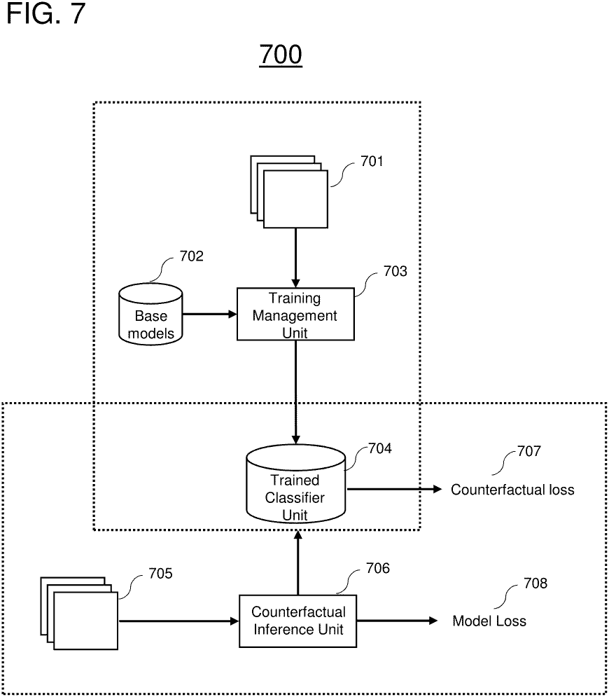

Next, an example of a training process for the classifier unit and the counterfactual inference unit with respect to tabular data will be described with reference to FIG. 7.

FIG. 7 is a diagram illustrating an example of a training process 700 for the classifier unit and the counterfactual inference unit, according to the embodiments of the present disclosure. The training processes 700 for the classifier unit and the counterfactual inference unit illustrated in FIG. 7 respectively correspond to Step S306 and Step S306 illustrated in FIG. 3, or Step S404 and Step S405 in FIG. 4.

First, a training management unit 703 receives a set of training data 701. Here, the training management unit 703 may include a software module or dedicated hardware configured to implement the training process 700 with respect to the classifier unit and the counterfactual inference unit. The set of training data 701 may include a set of tabular data or a set of image data for training the classifier unit to perform a given classification task. As an example, in the case of a classification task in which a classifier unit is trained to predict individuals whose income exceeds a threshold, the set of training data may include information regarding the age, education level, gender, nationality, and occupation of a number of individuals, together with ground truth data that indicates the correct classification label results for each individual.

Upon receiving the set of training data 701, the training management unit 703 may select, from a group of base models 702, an appropriate model type for performing the desired classification task. Here, the group of base models 702 may include a collection of machine learning models, networks, or algorithms that can be trained to perform the desired classification task. In embodiments, the training management unit 703 may receive a model selection instruction together with the set of training data 701 that indicates a particular model for use. As examples, the group of base models 702 may include artificial neural networks, deep learning algorithms, learning classifiers, Bayesian networks, or the like. Upon selection of a base model from the group of base models 702, the training management unit 703 utilizes the set of training data 701 to train the selected base model to perform the desired classification task (e.g., predicting whether or not an individual’s income exceeds a threshold). The training process 700 may be repeated until the base model achieves a desired accuracy level, and subsequently saved as the trained classifier unit 704.

Next, a counterfactual inference unit 706 is trained using a set of training data 705. The set of training data 705 may include a set of tabular data or image data used for training the counterfactual inference unit 220. In embodiments, the set of training data 204 may substantially correspond to the set of training data 701 used to train the trained classifier unit 704. Here, the counterfactual inference unit 706 is trained to perform encoding and decoding operations on an input data set to generate a set of transformed data that achieves the predetermined target of the trained classifier unit 704. As an example, in the case that the trained classifier unit 704 is trained to predict individuals whose income exceeds a threshold, the counterfactual inference unit 706 is trained to generate sets of transformed data in which a subset of the set of data features of the input data set are modified to counterfactual features (e.g., modifications to data features such as occupation, hours worked per week, or the like) such that the set of transformed data is classified as corresponding to an individual whose income will exceed the threshold. As will be described herein, the training of the counterfactual inference unit 706 is associated with a model loss 708. This model loss 708 will be described below.

The set of transformed data generated by the counterfactual inference unit 706 is input to the trained classifier unit 704. The trained classifier unit 704 processes the set of transformed data generated by the counterfactual inference unit 706 to determine whether the set of transformed data achieves a predetermined target (e.g., income above a threshold), and calculates an associated counterfactual loss 707. This counterfactual loss 707 arises from those samples of the transformed data that are determined to not achieve the predetermined target.

As described above, the counterfactual inference unit 220 is trained to reduce the model loss 708. Here, as illustrated in Equation 1, the model loss 708 (Lᵥ) is represented as the sum of a plurality of loss values.

$${L}_{v} = {L}_{k l} + {L}_{r e c o n} + {L}_{C F} + {L}_{p r o b}$$

Here, Lₖₗ represents the Kullback-Leibler divergence loss, L_{recon} represents the reconstruction loss resulting from the encoder-decoder processing, L_{CF} represents the counterfactual loss 707 arising from those samples of the transformed data that were determined to not achieve the predetermined target by the trained classifier unit 704, and L_{prob} represents the supplementary probabilistic loss of calculating the correlation between clusters of data features.

By adjusting the parameters of the counterfactual inference unit 706 to minimize this model loss 708 (Lᵥ), the counterfactual inference unit 706 is trained to generate sets of transformed data that achieve the predetermined target of the trained classifier unit 704.

In addition, it should be noted that in the training process 700, the masking operation described herein is not performed to mask a subset of the set of data features of the training data; that is, the training process 700 is performed without masking any data features. By performing the training process 700 without masking any data features of the training data, local convergence of the models can be prevented.

According to the training process 700 for the classifier unit and the counterfactual inference unit as described above, the counterfactual inference unit can be trained to generate sets of transformed data in which a subset of the set of data features of the input data set are modified to counterfactual features such that the set of transformed data achieves a predetermined target. These counterfactual features can be used to provide users with insights about actions to take to increase their likelihood of achieving a predetermined target (e.g., loan approval, income above a threshold).

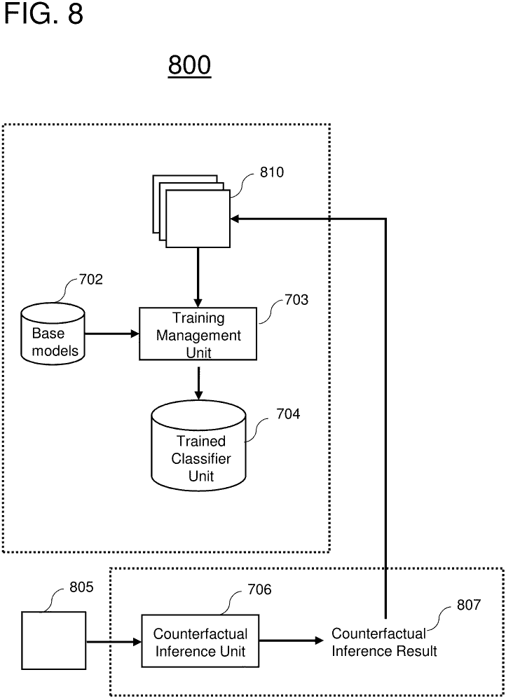

Next, an example of a feedback process of the counterfactual inference management device will be described with reference to FIG. 8.

FIG. 8 is a diagram illustrating an example of a feedback process 800 of the counterfactual inference management device, according to the embodiments of the present disclosure. The feedback process 800 may be executed in the inference phase of the counterfactual inference management device to utilize a counterfactual inference result as training data to further increase the accuracy of the classifier unit.

As illustrated in FIG. 8, first, the counterfactual inference unit 706 receives a set of test data 805 and generates a counterfactual inference result 807. In embodiments, a user may use a user interface unit (not illustrated in FIG. 8) to enter a user input in order to modify one or more of the data features of the set of transformed data included in the counterfactual inference result 807 to a user-selected counterfactual feature (e.g., a user may modify a data feature corresponding to their income or education level to observe how this affects their loan approval result).

Subsequently, this counterfactual inference result 807 together with the user input may be aggregated as a set of training data 810 and input to the training management unit 703. The training management unit 703 may then select, from a group of base models 702, an appropriate model type for performing a desired classification task, and train the selected model using the set of training data 810 to generate a trained classifier unit 704.

According to the feedback process 800 of the counterfactual inference management device, the counterfactual inference result 807 and the user input received from the user can be used to train a classifier unit. This trained classifier unit can then subsequently be used to train a counterfactual inference unit as described above. In this way, by means of training a classifier unit and a counterfactual inference unit based on the counterfactual inference result 807 and the user input received from the user, it becomes possible to generate flexible counterfactual inference results that provide users a range of options to customize based on their preferences.

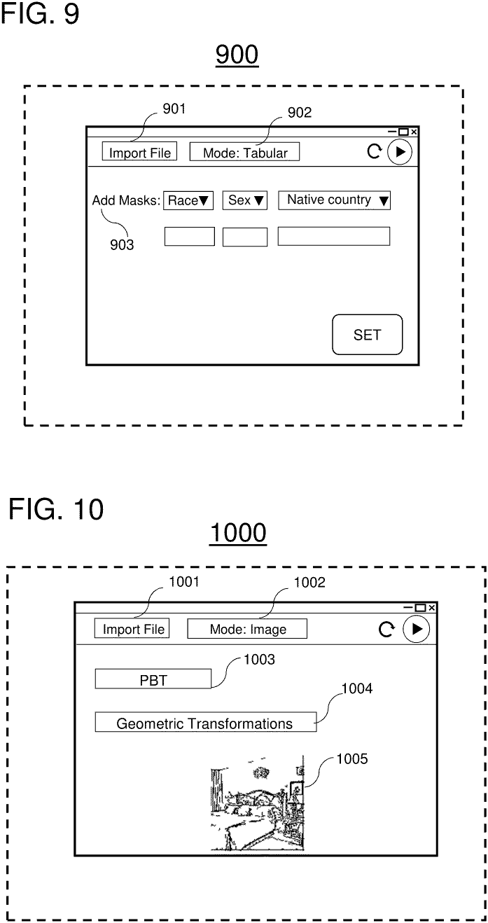

Next, an example of a mask selection window according to the embodiments of the present disclosure will be described with reference to FIG. 9.

FIG. 9 is a diagram illustrating an example of a mask selection window 900, according to the embodiments of the present disclosure. As described herein, aspects of the present disclosure relate to performing a masking operation to mask (e.g., freeze, lock, hold, maintain) one or more of the data features of the set of input data. In embodiments, users may select which data features of the set of input data to mask via a mask selection window 900 presented in a graphical user interface by the user interface unit (e.g., the user interface unit 240 illustrated in FIG. 2).

As illustrated in FIG. 9, the mask selection window 900 includes an import file button 901, a mode selection button 902, and a mask selection button 903.

By selecting the import file button 901, a user can select the set of input data (e.g., the set of test data to be used in the counterfactual inference generation process) including the set of data features they wish to mask.

By selecting the mode selection button 902, a user can select between a tabular mode for designating a tabular data processing operation (e.g., mask selection, data normalization) and an image mode for designating an image processing operation (e.g., pixel brightness operation, geometric transformation).

By selecting the mask selection button 903, a user can select the particular data features to which they wish to assign a mask. In embodiments, it may be preferable to assign masks to those data features that cannot be freely changed by the user. As an example, as illustrated in FIG. 9, the user may assign masks to data features of “race,” “sex,” and “native country,” as these are data features that cannot be freely changed by the user.

By means of the mask selection window 900, users can assign masks to any number of data features of the set of data features. In this way, by assigning masks to those data features that cannot be freely changed by the user, it is possible to suppress the generation of infeasible counterfactual inferences that require changes to data features that correspond to attributes that cannot be changed by the user.

Next, an example of an image import window according to the embodiments of the present disclosure will be described with reference to FIG. 10.

FIG. 10 is a diagram illustrating an example of an image import window 1000 according to the embodiments of the present disclosure. As described herein, aspects of the present disclosure relate to performing a counterfactual inference management method with respect to a set of image data. In embodiments, it may be desirable to perform an image processing operation with respect to the set of image data prior to the set of image data being input to a trained counterfactual inference unit. Accordingly, a user may use the image import window 1000 to select a set of image data and designate one or more image processing operations to perform on the set of image data.

As illustrated in FIG. 10, the image import window 1000 includes an import file button 1001, a mode selection button 1002, a pixel brightness operation button 1003, a geometric transformation button 1004, and an image display area 1005.

By selecting the import file button 1001, a user can select the set of image data to be used in the counterfactual inference generation process.

By selecting the mode selection button 1002, a user can select between a tabular mode for designating a tabular data processing operation (e.g., mask selection, data normalization) and an image mode for designating an image processing operation (e.g., pixel brightness operation, geometric transformation).

By selecting the pixel brightness operation button 1003, a user can select one or more pixel brightness operations to perform with respect to the set of image data. The pixel brightness operation may include an operation to increase or decrease the brightness of one or more pixels of the set of image data.

By selecting the geometric transformation button 1004, a user can select one or more geometric transformation operations to perform with respect to the set of image data. As examples, the geometric transformation operations may include translations, Euclidean transformations, resizing, scaling, or other operations to adjust the geometric features of elements of the set of image data.

In the image display area 1005, a preview of the set of image data selected by the user via the import file button 1001 is displayed. As an example, as illustrated in FIG. 10, the set of image data may include an image of a bedroom scene.

By means of the image import window 1000, users can select sets of image data to be used in the counterfactual inference process. Further, users can designate one or more image processing operations to perform on the set of image data. Performing one or more image processing operations on the set of image data may increase the accuracy of the counterfactual inference results generated by the counterfactual inference process.

Next, an example of a counterfactual inference result display for tabular data will be described with reference to FIG. 11.

FIG. 11 is a diagram illustrating an example of a counterfactual inference result display 1100 for tabular data, according to the embodiments of the present disclosure. The counterfactual inference result display 1100 is a graphical user interface configured to display the counterfactual inference result generated by the counterfactual inference unit of the present disclosure. As described herein, the counterfactual inference result may include the set of transformed data, a target achievement indicator that indicates whether the set of transformed data achieves the predetermined target, and a correlation indicator that indicates the correlation between particular data features of the set of transformed data. Further, the counterfactual inference result display 1100 may be configured to receive a user input to modify one or more data features of the set of transformed data. In embodiments, the counterfactual inference result display 1100 illustrated in FIG. 11 may be presented via the user interface unit.

As illustrated in FIG. 11, the counterfactual inference result display 1100 primarily includes a feature display area 1110, a target achievement indicator area 1120, and a correlation indicator area 1130.

The feature display area 1110 is a graphical user interface element for illustrating the data features of the set of transformed data. As described herein, in the case of tabular data, the set of transformed data may include a set of numerical features and a set of categorical features. As examples, in FIG. 11, numerical features such as feature 1, feature 2, and feature 3 may be represented using a slider, and categorical features such as feature 4, feature 5, and feature 6 may be represented using drop-down boxes.

As described herein, in embodiments, users of the counterfactual inference result display 1100 may enter a user input to modify one or more data features of the set of transformed data. As an example, in the case that feature 1 represents “income,” a user may use the slider for feature 1 to modify his or her income value to a counterfactual value to observe how this affects the counterfactual inference result. Similarly, in the case that feature 4 represents “occupation,” a user may use the drop-down box to modify his or her occupation to observe how this affects the counterfactual inference result.

The target achievement indicator area 1120 is a graphical user interface element for indicating whether the set of transformed data achieves the predetermined target. As an example, in the case that the predetermined target is “loan approval,” the target achievement indicator area 1120 may indicate “success” or “failure” of a loan applicant to be approved for a loan. In embodiments, the target achievement indicator area 1120 may be configured to automatically update in real time in response to the modifications to the data features made by the user. Accordingly, a user can observe in real time how modifications to the data features influence the counterfactual inference result.

The correlation indicator area 1130 is a graphical user interface element that indicates the correlation between particular data features of the set of transformed data. For example, as illustrated in FIG. 11, those features that are identified to be correlated to one another may be grouped as individual clusters in the correlation indicator area 1130. As an example, the correlation indicator area 1130 may group feature 1 and feature 4 in the same cluster to indicate a correlation between “income” and “occupation.” Accordingly, users may make modifications to the data features in consideration of the correlations indicated in the correlation indicator area.

Additionally, the counterfactual inference result display 1100 may include a save button 1135. By selecting the save button 1135, a user may save the counterfactual inference result to a designated storage area. In embodiments, upon saving the counterfactual inference results, the counterfactual inference results may be sent to the training management unit for use as training data to train a classifier unit.

According to the counterfactual inference result display 1100 illustrated in FIG. 11, users may view and confirm the counterfactual inference results generated by the counterfactual inference management device with respect to tabular data. Further, users may modify data features of the set of transformed data to counterfactual values to explore how changes to the input data affects the counterfactual inference results.

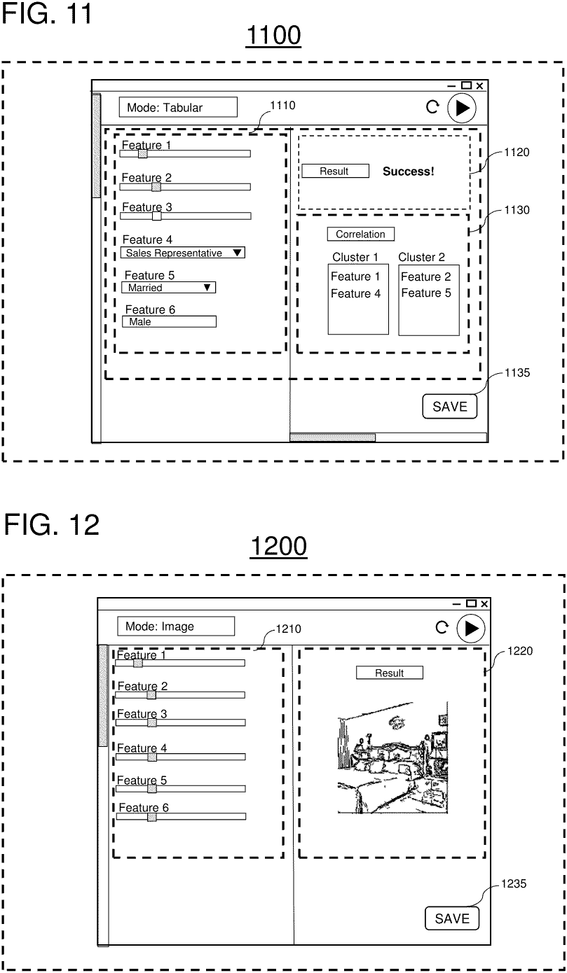

Next, an example of a counterfactual inference result display for image data will be described with reference to FIG. 12.

FIG. 12 is a diagram illustrating an example of a counterfactual inference result display 1200 for image data, according to the embodiments of the present disclosure. The counterfactual inference result display 1200 is a graphical user interface configured to display the counterfactual inference result generated by the counterfactual inference unit of the present disclosure. As described herein, the counterfactual inference result may display the set of transformed data (e.g., a transformed image) together with the data features of the transformed data. Further, the counterfactual inference result display 1200 may be configured to receive a user input to modify one or more data features of the set of transformed data. In embodiments, the counterfactual inference result display 1200 illustrated in FIG. 12 may be presented via the user interface unit.

As illustrated in FIG. 12, the counterfactual inference result display 1200 primarily includes a feature display area 1210 and a transformed image display area 1220.

The feature display area 1210 is a graphical user interface element for illustrating the data features of the set of transformed data. As described herein, in the case of image data, the set of transformed data may include a transformed image characterized by a set of image features. As examples, in FIG. 12, image features such as features 1-6 may be represented using a slider.

As described herein, in embodiments, users of the counterfactual inference result display 1200 may enter a user input to modify one or more data features of the set of transformed data. As an example, in the case that feature 1 represents “brightness,” a user may use the slider for feature 1 to modify the brightness level to a counterfactual value to observe how this affects the transformed image.

The transformed image display area 1220 is a graphical user interface element for illustrating the transformed image generated by the counterfactual inference unit. As an example, as illustrated in FIG. 12, in the case of an input image of a bedroom scene with no indoor lighting, the transformed image display area 1220 may display a transformed image in which the image features have been modified to illustrate the bedroom scene with indoor lighting. In embodiments, the transformed image display area 1220 may be configured to automatically update in real time in response to the modifications to the data features made by the user. Accordingly, a user can observe in real time how modifications to the data features influence the counterfactual inference result.

Additionally, the counterfactual inference result display 1200 may include a save button 1235. By selecting the save button 1135, a user may save the counterfactual inference result to a designated storage area. In embodiments, upon saving the counterfactual inference results, the counterfactual inference results may be sent to the training management unit for use as training data to train a classifier unit.

According to the counterfactual inference result display 1200 illustrated in FIG. 11, users may view and confirm the counterfactual inference results generated by the counterfactual inference management device with respect to image data. Further, users may modify data features of the set of transformed data to counterfactual values to explore how changes to the input data affects the counterfactual inference results.

As described herein, according to the counterfactual inference management device, counterfactual inference management method, and counterfactual inference management computer program product of the present disclosure, a variety of advantageous effects can be demonstrated.

For example, as the counterfactual inference unit is trained based on the output of a trained classifier unit, the trained counterfactual inference unit is capable of generating counterfactual inference results that include sets of transformed data in which one or more data features have been modified to counterfactual data features that achieve a predetermined target of the classifier unit. These counterfactual inference results may serve as recommendations to users that provide insight into how a particular outcome would change if the input factors were hypothetically changed.

Additionally, as the counterfactual inference management unit is trained based on user-selected counterfactual features, the trained counterfactual inference unit is capable of generating flexible counterfactual inference results that allow a user to explore a variety of hypothetical cases for achieving a predetermined target.

In addition, as the counterfactual inference unit utilizes a statistical analysis technique to predict data features that have a high probability of exhibiting correlation with one or other data features of the set of transformed data, users can easily eliminate infeasible counterfactual inferences (e.g., counterfactual inferences that require changes to one data feature but not another correlated feature may not be feasible).

Further, as the counterfactual inference unit may be configured to switch between separate operating modes and perform specialized processing steps based on whether the input data is tabular data or image data, the counterfactual inference management device is capable of generating counterfactual inference results with respect to both tabular data and image data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used, and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

### [REFERENCE SIGNS LIST]

100... Computer system
102... Processor
104... Memory
106... Memory bus
108... I/O bus
109... Bus IF
110... I/O Bus IF
112... Terminal interface
113... Storage interface
114... I/O device interface
115... Network interface
116... User I/O device
117... Storage device
124... Display system
126... Display
130... Network
150... Counterfactual inference management application
200... Counterfactual inference management device
210... Classifier unit
220... Counterfactual inference unit
230... Pre-processing unit
232... Tabular data processing unit
234... Image processing unit
240... User interface unit
250... Feedback unit

What is claimed is:

1. A counterfactual inference management device comprising:
a classifier unit trained to determine whether a set of input data that includes a set of data features achieves a predetermined target; and
a counterfactual inference unit for generating, by processing the set of input data, a set of transformed data in which a subset of the set of data features are modified to counterfactual features with respect to the set of input data; wherein:
the classifier unit processes the set of transformed data generated by the counterfactual inference unit to determine whether the set of transformed data achieves the predetermined target, and calculates a counterfactual loss value associated with a subset of the set of transformed data that does not achieve the predetermined target; and
the counterfactual inference unit is trained to reduce the counterfactual loss value and generate a second set of transformed data including counterfactual features that achieve the predetermined target.

2. The counterfactual inference management device according to claim 1, wherein:
the set of input data includes:
a set of tabular data having a set of data features including a set of numerical features or a set of categorical features; or
a set of image data having a set of data features including a set of image features.

3. The counterfactual inference management device according to claim 2, further comprising:
a pre-processing unit configured to:
determine whether the set of input data includes the set of tabular data or the set of image data; and
perform, in a case that the set of input data is determined to include the set of tabular data, a tabular data processing operation on the set of input data; and
perform, in a case that the set of input data is determined to include the set of image data, an image processing operation on the set of input data.

4. The counterfactual inference management device according to claim 3, wherein:
the pre-processing unit performs, as the tabular data processing operation, a normalization technique with respect to the set of numerical features and a one-hot encoding with respect to the set of categorical features.

5. The counterfactual inference management device according to claim 4, wherein:
the pre-processing unit performs, as the tabular data processing operation, a masking operation to prevent modification to a subset of the set of numerical features or a subset of the set of categorical features.

6. The counterfactual inference management device according to claim 5, wherein generating the set of transformed data includes:
generating, in a case that the set of input data is determined to include the set of tabular data, a latent space representation of the set of input data that is dimensionally reduced with respect to the set of tabular data by processing the set of tabular data with an encoder model;
generating the set of transformed data in which a subset of the set of data features are modified to counterfactual features with respect to the set of tabular data by processing the latent space representation with a decoder model; and
generating, by performing a statistical analysis technique on the set of transformed data, a set of cluster results that indicates a correlation between data features of the set of tabular data.

7. The counterfactual inference management device according to claim 3, wherein:
the pre-processing unit performs, as the image processing operation, one or more of a pixel brightness transformation and a geometric transformation.

8. The counterfactual inference management device according to claim 7, wherein generating the set of transformed data includes:
generating, in a case that the set of input data is determined to include the set of image data, a latent space representation of the set of image data that is dimensionally reduced with respect to the set of image data by processing the set of image data with an encoder model having a convolutional layer; and
generate the set of transformed data in which a subset of the set of data features are modified to counterfactual features with respect to the set of image data by processing the latent space representation with a decoder model having a convolutional layer.

9. The counterfactual inference management device according to claim 1, further comprising:
a user interface unit configured to:
present a counterfactual inference result that includes the second set of transformed data, a second set of data features characterizing the second set of transformed data, and a target achievement indicator that indicates whether the second set of transformed data achieves the predetermined target; and
receive a user input to modify a subset of the second set of data features of the second set of transformed data to a set of user-selected counterfactual features.

10. The counterfactual inference management device according to claim 9, further comprising:
a feedback unit configured to use the counterfactual inference result together with the set of user-selected counterfactual features as training data to train the classifier unit.

11. A counterfactual inference management method comprising:
training a classifier unit to determine whether a set of input data that includes a set of data features achieves a predetermined target;
generate, by processing the set of input data with a counterfactual inference unit, a set of transformed data in which a subset of the set of data features are modified to counterfactual features with respect to the set of input data;
processing, using the classifier unit, the set of transformed data generated by the counterfactual inference unit to determine whether the set of transformed data achieves the predetermined target, and calculating a counterfactual loss value associated with a subset of the set of transformed data that does not achieve the predetermined target; and
training the counterfactual inference unit to reduce the counterfactual loss value and generate a second set of transformed data including counterfactual features that achieve the predetermined target.

12. The counterfactual inference management method according to claim 11, further comprising:
receiving a set of test data;
determining whether the set of test data includes a set of tabular data or a set of image data;
performing, in a case that the set of test data is determined to include the set of tabular data, a tabular data processing operation on the set of test data;
performing, in a case that the set of test data is determined to include the set of image data, an image processing operation on the set of test data;
generate, by processing the set of test data with the counterfactual inference unit, a third set of transformed data including counterfactual features that achieve the predetermined target;
presenting, to a user via a graphical user interface, a counterfactual inference result that includes the third set of transformed data, a third set of data features characterizing the third set of transformed data, and a target achievement indicator that indicates whether the third set of transformed data achieves the predetermined target;
receiving, via the graphical user interface, a user input to modify a subset of the third set of data features of the third set of transformed data to a set of user-selected counterfactual features; and
training the classifier unit using the counterfactual inference result together with the set of user-selected counterfactual features.

13. A counterfactual inference management computer program product comprising a computer readable storage medium having program instructions embodied therewith, wherein the computer readable storage medium is not a transitory signal per se, the program instructions executable by a processor to cause the processor to perform a method comprising:
training a classifier unit to determine whether a set of input data that includes a set of data features achieves a predetermined target;
generating, by processing the set of input data with a counterfactual inference unit, a set of transformed data in which a subset of the set of data features are modified to counterfactual features with respect to the set of input data;
processing, using the classifier unit, the set of transformed data generated by the counterfactual inference unit to determine whether the set of transformed data achieves the predetermined target, and calculating a counterfactual loss value associated with a subset of the set of transformed data that does not achieve the predetermined target; and
training the counterfactual inference unit to reduce the counterfactual loss value and generate a second set of transformed data including counterfactual features that achieve the predetermined target.

14. The counterfactual inference management computer program product according to claim 13, further comprising:
receiving a set of test data;
determining whether the set of test data includes a set of tabular data or a set of image data;
performing, in a case that the set of test data is determined to include the set of tabular data, a tabular data processing operation on the set of test data;
performing, in a case that the set of test data is determined to include the set of image data, an image processing operation on the set of test data;
generating, by processing the set of test data with the counterfactual inference unit, a third set of transformed data including counterfactual features that achieve the predetermined target;
presenting, to a user via a graphical user interface, a counterfactual inference result that includes the third set of transformed data, a third set of data features characterizing the third set of transformed data, and a target achievement indicator that indicates whether the third set of transformed data achieves the predetermined target;
receiving, via the graphical user interface, a user input to modify a subset of the third set of data features of the third set of transformed data to a set of user-selected counterfactual features; and
training the classifier unit using the counterfactual inference result together with the set of user-selected counterfactual features.
